(19) United States
(12) Patent Application Publication
(10) Pub. No.: US 2021/0102054 A1
(43) Pub. Date: Apr. 8, 2021

(54) RESIN COMPOSITION

(71) Applicant: NIPPON PAPER INDUSTRIES CO., LTD., Kita-ku (JP)

(72) Inventors: Masaru KONO, Tokyo (JP); Hitomi ABE, Tokyo (JP); Junichi HAYAKAWA, Tokyo (JP); Minoru YADA, Tokyo (JP); Naosuke KOMOTO, Tokyo (JP)

(73) Assignee: NIPPON PAPER INDUSTRIES CO., LTD., Kita-ku (JP)

(21) Appl. No.: 16/971,899

(22) PCT Filed: Feb. 28, 2019
(86) PCT No.: PCT/JP2019/007854

§ 371 Date: Aug. 21, 2020

(30) Foreign Application Priority Data
Mar. 1, 2018 (JP) 2018-036784

(51) Int. Cl. C08L 23/28; C09D 5/00; C09D 123/28

(52) U.S. Cl. CPC C08L 23/28; C09D 123/28; C09D 5/002

(57) ABSTRACT

A resin composition can be used as a raw material of a primer, and capable of superior solution stability, adhesion to a non-polar substrate, and/or chipping resistance in a coating film formed from the composition. The resin composition includes a component A: a modified polyolefin resin, and a component B: a polymer having a functional group at least in a terminal thereof, and having a number-average molecular weight in a range of 1,000 to 20,000, and containing a constituent unit (i) derived from a (meth)acrylate ester of a formula, CH₂═C(R¹)COOR², wherein R¹ is a hydrogen atom or a methyl group, R² is a —CₙH₂ₙ₊₁ group, and n is an integer of 1 to 18)

### FIELD

The present invention relates to a resin composition.

### BACKGROUND

A polyolefin substrate such as polypropylene is not only superior in its performance but also inexpensive. Therefore, the polyolefin substrate is widely used in plastic molded parts and various films of food packaging materials, among others. When the polyolefin substrate is used, in order to protect the surface thereof and to improve outer appearance, surface of the polyolefin substrate is often printed or painted.

The polyolefin substrate is a non-polar substrate that is low in surface free energy and also has crystallinity. Because of these, there is a problem in the polyolefin substrate that an ink or a paint is difficult to adhere thereto. In view of the problem like this, an approach is widely taken to add a chlorinated polyolefin resin to an ink or a paint so as to enhance an adhesion property thereof to the polyolefin substrate in printing, painting or the like.

Also as a part belonging to an automobile outer plate portion as well as a part in home electric appliances, many plastic molded articles such as polyolefin substrates are used. Usually, with an aim to enhance an adhesion property between an overcoat film and the molded article, before overcoating, a primer containing a chlorinated polyolefin resin or the like is coated on the plastic molded article.

In recent years, in painting of an automobile outer plate portion, a method is proposed with which painting is carried out after a plastic molded article is integrated with the automobile outer plate portion (for example, see Patent Literature 1). In the painting method like this, painting lines can be unified so that reduction in the paint amount to be used, thereby resulting in reduction in the cost relating thereto, may be expected.

### CITATION LIST

### Patent Literature

Patent Literature 1: Japanese Patent Application Laid-open No. 2012-213692

### SUMMARY

### Technical Problem

In the painting method described in Patent Literature 1, a primer coating is made not only to a plastic molded article but also to an automobile outer plate portion, which is made of a metal. Therefore, when a coat film having a constant thickness is formed on the automobile outer plate portion, an overcoat layer becomes thin by the thickness of the primer layer. In addition, the primer layer is low in a resistance to a peel-off of a coat film caused by a chipping stone (chipping resistance), so that there is a problem of a decrease in the chipping resistance of the entire painted body.

An electrodeposition may be a widely used painting method of the automobile outer plate portion. The electrodeposition treatment utilizes a difference in polarities between a material to be painted and a paint; therefore, the paint to be used in the electrodeposition needs to have a comparatively high polarity. Because of this, surface of the electrodeposition is highly polar so that increase in amount of a polar functional group in a primer resin is desirable. There is a problem in it, however, that the increase in amount of the polar functional group generally deteriorates a solution property thereof so that practical use thereof becomes difficult.

An object of the present invention is to provide a resin composition capable of becoming a raw material of a primer, the composition being superior in solution stability and an adhesion property to a non-polar substrate, as well as being capable of forming a coat film that is superior also in a chipping resistance.

### Solution to Problem

The inventors of the present invention carried out an extensive investigation on the problem described above; and as a result, it was found that the problem could be solved by mixing a modified polyolefin resin with a polymer having a functional group at least in a terminal thereof, and having a number-average molecular weight in the range of 1,000 to 20,000, and containing a constituent unit derived from a (meth)acrylate ester. The present invention could be completed on the basis of these findings.

Namely, the inventors of the present invention provide following [1] to [8].

[1] A resin composition comprising a following component A and a following component B:

component A: a modified polyolefin resin, and

component B: a polymer having a functional group at least in a terminal thereof, and having a number-average molecular weight in a range of 1,000 to 20,000, and containing a constituent unit (i) derived from a (meth)acrylate ester represented by a following general formula (1):

CH₂═C(R¹)COOR² (1):

in the general formula (1), R¹ represents a hydrogen atom or a methyl group; R² represents a group represented by —CₙH₂ₙ₊₁; and n represents an integer of 1 to 18.
[2] The resin composition according to [1], wherein the component A is a modified polyolefin resin modified with a following component C:

component C: a (meth)acrylate ester.

[3] The resin composition according to [1] or [2], wherein the constituent unit (i) contains 40% or more of a constituent unit (i-i) derived from a (meth)acrylate ester whose carbon atom number is in a range of 4 to 12 in the compound represented by the general formula (1).
[4] The resin composition according to any one of [1] to [3], wherein the component C is a (meth)acrylate ester whose carbon atom number is in a range of 4 to 12.
[5] The resin composition according to any one of [1] to [4], wherein the component A is a chlorinated polyolefin resin.
[6] The resin composition according to any one of [1] to [5], wherein a weight-average molecular weight of the component A is in a range of 20,000 to 200,000.
[7] The resin composition according to any one of [1] to [6], wherein the terminal functional group is a carboxy group.
[8] A primer comprising the resin composition according to any one of [1] to [7].

### Advantageous Effects of Invention

According to the present invention, a resin composition capable of becoming a raw material of a primer can be provided, the composition being superior in solution stability and an adhesion property to a non-polar substrate, as well as being capable of forming a coat film that is superior also in a chipping resistance.

### DESCRIPTION OF EMBODIMENTS

Hereinafter, the present invention will be explained in detail on the basis of preferable embodiments thereof.

It must be noted here that “(meth)acrylic acid” is a collective term of acrylic acid and methacrylic acid, and that “(meth)acryl-modified” is a collective term of acryl-modified and methacryl-modified.

1. Resin Composition

The resin composition of the present invention includes a component A: a modified polyolefin resin and a component B: a polymer having a functional group at least in a terminal thereof, and having a number-average molecular weight in the range of 1,000 to 20,000, and containing a constituent unit (i) derived from a (meth)acrylate ester represented by a following general formula (1). The resin composition of the present invention may be a resin composition of the component A mixed with the component B, or a resin composition that is obtained, after the component A is mixed with the component B, by modifying a resulting mixture with a modifying agent (for example with chlorine and/or an acid).

CH₂═C(R¹)COOR² (1):

(In the general formula (1), R¹ represents a hydrogen atom or a methyl group; R² represents a group represented by —CₙH₂ₙ₊₁; and n represents an integer of 1 to 18.)

The resin composition of the present invention includes the component A, so that the resin composition capable of becoming a raw material of a primer can be provided, the composition being capable of forming a coat film that is superior in an adhesion property to a non-polar substrate as well as in a chipping resistance. In addition, the resin composition of the present invention includes the component B, so that the composition is superior in solution stability.

In the resin composition of the present invention, it is preferable to use a chlorinated resin. “Chlorinated resin” mentioned herein includes a resin having the component A chlorinated, a resin having the component B chlorinated, and a resin having the component A and the component B chlorinated. In the resin composition of the present invention, it is more preferable to use the resin having the component A chlorinated.

1-1. Component A

The component A is a modified polyolefin resin. The resin composition of the present invention includes the modified polyolefin resin, so that the present invention can provide a resin composition capable of becoming a raw material of a primer, the composition being capable of forming a coat film that is superior in an adhesion property to a non-polar substrate as well as in a chipping resistance.

Polyolefin Resin

The polyolefin resin may be a polymer of an olefin. Among the polymers of olefins, the polyolefin resin is preferably a polyolefin resin obtained by using a Ziegler-Natta catalyst or a metallocene catalyst as a polymerization catalyst thereof, more preferably a polypropylene resin or a polyolefin resin obtained by copolymerizing propylene with an α-olefin (for example, ethylene, butene, 3-methyl-1-butene, and 3-methyl-1-heptene) by using a Ziegler-Natta catalyst or a metallocene catalyst as a polymerization catalyst thereof, and still more preferably a propylene random copolymer obtained by using a metallocene catalyst as a polymerization catalyst thereof, while far more preferably polypropylene, an ethylene-propylene copolymer, a propylene-butene copolymer, or an ethylene-propylene-butene copolymer obtained by using a metallocene catalyst as a polymerization catalyst thereof. The polyolefin resin obtained by using a metallocene catalyst has characteristics of a narrow molecular weight distribution, a superior random copolymerization tendency, a narrow composition distribution, and a wide range of copolymerizable comonomers.

Here, the propylene random copolymer means polypropylene or polyolefin resins obtained by random copolymerization of propylene with an α-olefin; and illustrative examples thereof include polypropylene, an ethylene-propylene copolymer, a propylene-butene copolymer, an ethylene-propylene-diene copolymer, and an ethylene-propylene-butene copolymer.

The (co)polymer to constitute the polyolefin resin may be only a single polymer, or a combination of plurality of these (co)polymers.

With regard to the metallocene catalyst, catalysts that are heretofore known can be used. For example, a catalyst obtained by combining a component (1), a component (2), and when necessary a component (3), as described below, may be used. Especially, with regard to the metallocene catalyst, a catalyst obtained by combining the component (1) and the component (2), and when necessary the component (3) is preferable.

Component (1): a metallocene complex that is a compound of a transition metal belonging to the group 4 to the group 6 in the periodic table with at least one ligand having a conjugated 5-membered ring.

Component (2): an ion-exchangeable layered silicate salt.

Component (3): an organic aluminum compound.

A structure of the polyolefin resin may be any of the structures that can be possessed by usual polymer compounds, such as, for example, an isotactic structure, an atactic structure, and a syndiotactic structure. Among these structures, in view of an adhesion property to a polyolefin substrate, especially in view of an adhesion property under a low temperature and dry condition, a polyolefin resin having an isotactic structure, which can be obtained by using the metallocene catalyst, is preferable.

In the component composition of the polyolefin resin, a content by percentage of a propylene constituent unit is preferably 60% or more by weight, and more preferably 70% or more by weight, while still more preferably 80% or more by weight. When the propylene component is 60% or more by weight, an attachment property (adhesion property) to a polypropylene substrate can be further enhanced.

The content by percentage of the propylene constituent unit in the polyolefin resin may be a use ratio of raw materials, or a value calculated by an NMR analysis. Here, these values usually coincide with each other.

Modification

The component A is a modified substance of a polyolefin resin. Illustrative examples of the modification method thereof include heretofore known methods such as chlorination, epoxidation, hydroxylation, anhydrocarboxylation, carboxylation, and (meth)acryl-modification. The modified polyolefin resin may be prepared by modifying a polyolefin resin with a heretofore known method.

(Meth)acryl-Modification

The modified polyolefin resin is preferably a modified polyolefin resin that is modified with a component C: a (meth)acrylate ester, while more preferably a modified polyolefin resin that is modified with a (meth)acrylate ester whose carbon atom number is in the range of 4 to 12. Illustrative examples of the (meth)acrylate ester include 2-ethylhexyl (meth)acrylate, methyl (meth)acrylate, cyclohexyl (meth)acrylate, butyl (meth)acrylate, and 2-hydroxyethyl (meth)acrylate.

Modification operation of the polyolefin resin with the (meth)acrylate ester will be described later.

A weight ratio of the resin to the component C (resin/component C) is preferably in the range of 10/90 to 90/10, and more preferably in the range of 30/70 to 80/20, while still more preferably in the range of 50/50 to 70/30.

The weight ratio of the resin to the component C can be calculated from the use amount of the component C relative to the resin. Here, the “resin” means the polyolefin resin itself, or a resin, such as an acid-modified chlorinated polyolefin resin, which is used for a modification reaction with the component C.

(Anhydro)carboxylation

The modified polyolefin resin may be an acid-modified substance having a polyolefin resin modified with a carboxylic acid. There is no particular restriction in the carboxylic acid. Illustrative examples thereof include α,β-unsaturated carboxylic acids and derivatives of the α,β-unsaturated carboxylic acids (for example, maleic acid, maleic anhydride, fumaric acid, citraconic acid, citraconic anhydride, mesaconic acid, itaconic acid, itaconic anhydride, aconitic acid, aconitic anhydride, hymic anhydride, and (meth)acrylic acid). In particular, the carboxylic acid is preferably acid anhydrides of the α,β-unsaturated carboxylic acids or (meth)acrylic acids, while more preferably maleic anhydride or (meth)acrylic acids.

When the polyolefin resin is modified with an acid, the content by percentage of the acid is preferably in the range of 1.0 to 20% by weight, and more preferably in the range of 2.0 to 15% by weight, while still more preferably in the range of 2.5 to 10% by weight.

The content by percentage of the acid may be measured with a heretofore known method. For example, the content by percentage may be obtained by an alkali titration method.

Chlorination

The modified polyolefin resin may be a chlorinated polyolefin resin that is obtained by chlorination of a polyolefin resin.

When a polyolefin resin is chlorinated, the chlorine content by percentage therein is preferably 10% or more by weight, while more preferably 15% or more by weight. When the chlorine content by percentage therein is 10% or more by weight, the modified polyolefin resin thus obtained becomes superior in a dispersion property into various solvents including alcohols such as ethanol and isopropyl alcohol. The upper limit of the chlorine content by percentage is preferably 40% or less by weight. When the chlorine content by percentage is 40% or less by weight, the modified polyolefin resin thus obtained becomes superior in an adhesion property to a polyolefin substrate.

When the chlorine content by percentage is within this range, it is presumed that not only polarity of the modified polyolefin resin increases but also the modified polyolefin resin tends to readily have a linear structure because of a steric repulsion among the chlorine atoms. Therefore, it is presumed that the resin composition becomes superior in a dispersion property into various organic solvents and in an adhesion property to the substrate.

The chlorine content by percentage can be measured on the basis of JIS-K7229 (1995).

The modified polyolefin resin may also be a modified polyolefin resin that is obtained by modification of a polyolefin resin with a plurality of modifying materials. An illustrative example of the modified polyolefin resin mentioned above includes a modified polyolefin resin that is modified with at least two modifications selected from (meth)acryl-modification, carboxylation, and chlorination.

In the case that the modified polyolefin resin is a modified polyolefin resin that is obtained by a plurality of modifications with a plurality of modification materials, the modifications may be carried out all at once or separately. Hereinafter, an example will be explained in which after modification with an acid, a chlorination treatment is carried out, which is then further followed by (meth)acryl-modification.

First, a polyolefin resin is modified with an acid. The modification of a polyolefin resin with an acid can be done by using a heretofore known method. A known example thereof may be a method in which a polyolefin resin is melted, and then, added with an acid for modification as well as a radical reaction initiator. There is no particular restriction in a reaction apparatus; for example, a modification reaction may be carried out by using an extruder.

Next, the acid-modified polyolefin resin is chlorinated. Chlorination may be done by using a heretofore known method. A known example thereof may be a method in which after the acid-modified polyolefin resin is dissolved in a chlorine-based solvent such as chloroform, a chlorine gas is blown into a resulting solution so as to introduce chlorine into the resin. More specifically, this chlorination can be carried out as follows. The acid-modified polyolefin resin is dispersed or dissolved into a medium such as water, carbon tetrachloride, or chloroform, and then, a chlorine gas is blown into a resulting solution in the presence of a catalyst or with irradiating a UV light under a pressurized condition or a normal pressure in a temperature range of 50 to 140° C.

When a chlorine-based solvent is used in the chlorination, usually this chlorine-based solvent can be removed by distillation under a reduced pressure, or may be displaced with a different solvent.

Finally, the acid-modified chlorinated polyolefin resin that is obtained by acid-modification and chlorination is (meth)acryl-modified. The (meth)acryl-modification may be done, for example, by copolymerizing the acid-modified chlorinated polyolefin resin with the component C. The component C may be added to the acid-modified chlorinated polyolefin resin gradually or all at once. A monomer other than the component C may also be added to the acid-modified chlorinated polyolefin resin.

This copolymerization may be carried out with a heretofore known method such as a fusion method or a solution method. The fusion method has merits that not only the procedure thereof is simple but also that a reaction can be completed within a short time. The solution method has a merit that a side reaction is less so that a modified polyolefin resin that is uniformly graft-polymerized can be obtained.

In the fusion method, in the presence of a radical reaction initiator, the acid-modified chlorinated polyolefin resin is melted by heating (fusion by heating); and then, this is caused to react with the component C. The component C may be in the form of a monomer before polymerization or in the form of a polymer after polymerization. The temperature of the melting by heating may be equal to or higher than a melting point of the acid-modified chlorinated polyolefin resin, while preferably in the range of the temperature equal to or higher than a melting point of the acid-modified chlorinated polyolefin resin and the temperature equal to or lower than 300° C. At the time of melting by heating, equipment such as a Bunbury mixer, a kneader, or an extruder can be used.

In the solution method, the acid-modified chlorinated polyolefin resin is dissolved into an organic solvent; and then, the reaction is carried out by heating the resulting solution together with the component C in the presence of a radical reaction initiator with stirring. The component C may be in the form of a monomer before polymerization or in the form of a polymer after polymerization.

An aromatic hydrocarbon solvent such as toluene or xylene is preferably used as the organic solvent. The temperature of the reaction is preferably in the range of 100 to 180° C.

Illustrative examples of the radical reaction initiator to be used in the fusion method and in the solution method include organic peroxide compounds and azo nitrile compounds.

Illustrative examples of the organic peroxide compound include di-tert-butyl peroxide, dicumyl peroxide, tert-butyl cumyl peroxide, benzoyl peroxide, dilauryl peroxide, 2,5-dimethyl-2,5-di(tert-butylperoxy)hexane, cumene hydroperoxide, tert-butyl hydroperoxide, 1,1-bis(tert-butylperoxy)-3,5,5-trimethylcyclohexane, 1,1-bis(tert-butylperoxy)-cyclohexane, cyclohexanone peroxide, tert-butylperoxy benzoate, tert-butylperoxy isobutyrate, tert-butylperoxy-3,5,5-trimethyl hexanoate, tert-butylperoxy-2-ethyl hexanoate, tert-butylperoxy isopropyl carbonate, and cumylperoxy octoate. A radical reaction initiator having a suitable half-life temperature in accordance with the radial polymerization temperature may be selected.

Stabilizer

In the case that the acid-modified chlorinated polyolefin resin is (meth)acryl-modified, the modification may be carried out in the form that the acid-modified chlorinated polyolefin resin contains an arbitrary stabilizer.

Illustrative examples of the arbitrary stabilizer include epoxy compounds; metal soaps used as a stabilizer for a polyvinylchloride resin, such as calcium stearate and lead stearate; organometallic compounds such as dibutyltin dilaurate and dibutyl maleate; and hydrotalcite compounds.

There is no particular restriction in the epoxy compound, although an epoxy compound that is compatible with the resin modified with chlorination and the like is preferable. An example thereof may be a compound having an epoxy equivalent in the range of about 100 to 500 and having one or more epoxy groups per one molecule. Illustrative examples of the epoxy compound like this include an epoxidized plant oil that is obtained by epoxidizing a natural plant oil having an unsaturated group with a peracid such as peracetic acid (epoxidized soybean oil, epoxidized linseed oil, and the like); an epoxidized aliphatic acid ester that is obtained by epoxidizing an unsaturated aliphatic acid such as oleic acid, a tall oil aliphatic acid, and a soybean oil aliphatic acid; an epoxidized alicyclic compound such as epoxidized tetrahydrophthalate; an ether that is obtained by condensation of bisphenol A or a polyalcohol with epichlorohydrin, such as bisphenol A glycidyl ether, ethylene glycol glycidyl ether, propylene glycol glycidyl ether, glycerol poly-glycidyl ether, and sorbitol polyglycidyl ether; and a mono-epoxy compound represented by butyl glycidyl ether, 2-ethylhexyl glycidyl ether, decyl glycidyl ether, stearyl glycidyl ether, allyl glycidyl ether, phenyl glycidyl ether, sec-butylphenyl glycidyl ether, tert-butylphenyl glycidyl ether, and phenol polyethylene oxide glycidyl ether.

The stabilizer may be one kind alone or a combination of two or more kinds thereof.

In the case that the modification is carried out in the form that the acid-modified chlorinated polyolefin resin includes the arbitrary stabilizer, the weight rate by percentage of the stabilizer relative to the acid-modified chlorinated polyolefin resin is preferably in the range of 1 to 20% by weight (in terms of solid content).

Physical Properties

The lower limit of the weight-average molecular weight (Mw) of the component A is preferably 20,000 or more. When the weight-average molecular weight is 20,000 or more, coagulation force of the modified polyolefin resin is sufficient so that the adhesion property of the resin composition to a substrate is superior. The upper limit thereof is preferably 200,000 or less. When the weight-average molecular weight is 200,000 or less, compatibility with a resin other than the component included in the paint is sufficient so that the adhesion property of the resin composition to a substrate can be excellent. In an embodiment of the weight-average molecular weight of the component A, the weight-average molecular weight thereof is preferably in the range of 20,000 to 200,000.

The weight-average molecular weight can be obtained from a calibration line of a standard polystyrene with a gel permeation chromatography (GPC) method.

Here, the weight-average molecular weight of the component A usually coincides with the measured weight-average molecular weight of the chlorinated polyolefin resin before the modification procedure.

1-2. Component B

The component B is a polymer having a functional group at least in a terminal thereof, and having a number-average molecular weight in the range of 1,000 to 20,000, and containing a constituent unit (i) derived from a (meth)acrylate ester represented by a following general formula (1). The resin composition of the present invention includes the component B so that the composition is superior in solution stability.

CH₂═C(R¹)COOR² (1):

(In the general formula (1), R¹ represents a hydrogen atom or a methyl group; R² represents a group represented by —CₙH₂ₙ₊₁; and n represents an integer of 1 to 18.)

Here, the term “constituent unit derived from a certain monomer” means the constituent unit obtained when a certain monomer is used in a polymerization reaction.

When the carbon atom number of the (meth)acrylate ester represented by the general formula (1) is in the range of 4 to 12, a primer formed of the resin composition can give a coat film having a further improved chipping resistance so that this is preferable.

Constituent Unit of the Component B

The component B contains a constituent unit (i) derived from the (meth)acrylate ester represented by the general formula (1). When the component B contains a constituent unit (i-i) derived from a (meth)acrylate ester whose carbon atom number is in the range of 4 to 12 in the compound represented by the general formula (1) (hereinafter, this is also called a constituent unit (i-i)), the content by percentage of the constituent unit (i-i) in the component B is preferably 40% or more by weight, while more preferably 60% or more by weight. By so doing, when the resin composition is combined with other component so as to give, for example, a paint composition, compatibility thereof with the other component can be excellent. Also, because a primer formed of the resin composition has an appropriate flexibility, a coat film capable of having a chipping resistance improved can be formed. In addition, when the modified polyolefin resin is mixed with the component B, compatibility between them is improved, thereby resulting in improvement of the solution stability.

Usually the content by percentage of the constituent unit (i-i) coincides with a weight percentage of the monomer that is the (meth)acrylate ester represented by the general formula (1) whose carbon atom number is in the range of 4 to 12, relative to a total weight of the monomers used for preparation of the polymer.

The constituent unit (i) may be only one constituent unit, or two or more constituent units.

The component B may contain a constituent unit other than the constituent unit (i) (hereinafter, this is also called “other constituent unit”). Illustrative examples of the other constituent unit include: constituent units derived from α,β-unsaturated carboxylic acids (for example, the constituent unit derived from (meth)acrylic acid), constituent units derived from α,β-unsaturated carboxylate esters (for example, hydroxyalkyl (meth)acrylate esters) other than the constituent unit (i); and a constituent unit derived from an aromatic compound having an unsaturated bond (for example, divinylbenzene).

Functional Group

Illustrative examples of the functional group possessed by the polymer include a carboxy group, a hydroxy group, an alkoxysilyl group, an amide group, and a thiol group. The polymer may contain only one, or two or more of these functional groups. When the polymer contains these functional groups, affinity thereof to the electrodeposited surface is enhanced thereby enhancing the adhesion property when the resin composition is used.

Introduction of the functional group into at least a terminal of the polymer can be done with a heretofore known method. Illustrative examples of the method include: a method in which a (meth)acrylate ester is polymerized by using a thiol having at least one functional group in its molecule as well as a proper radical reaction initiator; and a method in which a reversible addition fragmentation chain transfer (RAFT) polymerization is carried out by using a reagent having a functional group. The polymerization of a (meth)acrylate ester by using a thiol having at least one functional group in its molecule as well as a proper radical reaction initiator has a merit that the cost thereof is lower than the reversible addition fragmentation chain transfer (RAFT) polymerization by using a reagent having a functional group.

An example thereof will be explained by the method in which a carboxy group is introduced as the functional group. When a thiol having at least one carboxy group in its molecule and a proper radical reaction initiator are used, a thiol-ene reaction takes place between the thiol having a carboxy group and a (meth)acrylate ester so that the carboxy group derived from the thiol is introduced into a terminal of a (meth)acrylate ester polymer.

Illustrative examples of the thiol having at least one functional group in its molecule include: thiols containing a carboxyl group, such as α-mercapto propionic acid (thiolactic acid), β-mercapto propionic acid, 2,3-dimercapto propionic acid, thioglycolic acid, o-mercapto benzoic acid (thiosalicylic acid), m-mercapto benzoic acid, p-mercapto benzoic acid, thiomalic acid, thiol carbonic acid, o-thiocumaric acid, α-mercapto butanoic acid (mercapto butyric acid), β-mercapto butanoic acid, γ-mercapto butanoic acid, thiol histidine, and 11-mercapto undecanoic acid; thiols having a hydroxy group, such as mercapto methanol, 1-mercapto ethanol, 1-mercapto propanol, 1-mercapto-2,3-propanediol, 1-mercapto-2-butanol, 1-mercapto-2,3-butanediol, 1-mercapto-3,4-butanediol, 1-mercapto-3,4,4′-butanetriol, 2-mercapto-3-butanol, 2-mercapto-3,4-butanediol, and 2-mercapto-3,4,4′-butanetriol; and thiols having an alkoxysilyl group, such as 3-mercaptopropyl trimethoxy silane, 3-mercaptopropyl triethoxy silane, 3-mercaptopropyl monomethyl dimethoxy silane, 3-mercaptopropyl monophenyl dimethoxy silane, 3-mercaptopropyl dimethyl monomethoxy silane, 3-mercaptopropyl monomethyl diethoxy silane, 4-mercaptobutyl trimethoxy silane, and 3-mercaptobutyl trimethoxy silane.

Illustrative examples of the radical reaction initiator that is used with the thiol having at least one functional group in its molecule include organic peroxide compounds and azonitriles.

Illustrative examples of the organic peroxide compound include di-tert-butyl peroxide, dicumyl peroxide, tert-butyl cumyl peroxide, benzoyl peroxide, dilauryl peroxide, 2,5-dimethyl-2,5-di(tert-butylperoxy)hexane, cumene hydroperoxide, tert-butyl hydroperoxide, 1,1-bis(tert-butylperoxy)-3,5,5-trimethylcyclohexane, 1,1-bis(tert-butylperoxy)-cyclohexane, cyclohexanone peroxide, tert-butylperoxy benzoate, tert-butylperoxy isobutyrate, tert-butylperoxy-3,5,5-trimethyl hexanoate, tert-butylperoxy-2-ethyl hexanoate, tert-butylperoxy isopropylcarbonate, and cumylperoxy octoate. Here, the radical reaction initiator having a suitable half-life temperature in accordance with the temperature of the radical polymerization may be selected.

The component B is preferably a polymer having a functional group introduced into both terminals thereof. Heretofore known methods may be used as the method to introduce a functional group into both terminals of a polymer. Illustrative examples of the method include: a method in which a (meth)acrylate ester is polymerized by using an initiator having a functional group and a (meth)acrylate ester having a functional group and an unsaturated carbon-carbon double bond (hereinafter, this is also called “(meth)acrylate ester having a functional group”); and a method in which a reversible addition fragmentation chain transfer (RAFT) polymerization is carried out by using a reagent having a functional group.

Number-Average Molecular Weight

The number-average molecular weight (Mn) of the component B is in the range of 1,000 to 20,000, and preferably in the range of 1,500 to 15,000, while still more preferably in the range of 2,000 to 10,000.

That the number-average molecular weight of the component B is small means that the molecular size of the component B is small. Therefore, an entropy change amount upon mixing with the component A increases thereby leading to improvement in the compatibility thereof. When the molecular weight of the component B is more than 20,000, this effect is sometimes difficult to be obtained. When the molecular weight of the component B is less than 1,000, an adhesion property to a substrate can be deteriorated.

The ratio by weight of the component A to the component B in the resin composition (component A/component B) is preferably in the range of 90/10 to 10/90, more preferably in the range of 90/10 to 20/80, while still more preferably in the range of 90/10 to 50/50.

1-3. Arbitrary Component

The resin composition of the present invention may include, in addition to the component A and the component B, other arbitrary component. An example of the arbitrary component may be a stabilizer to suppress elimination of chlorine.

Illustrative examples of the stabilizer include epoxy compounds; metal soaps used as a stabilizer for a polyvinylchloride resin, such as calcium stearate and lead stearate; organometallic compounds such as dibutyltin dilaurate and dibutyl maleate; and hydrotalcite compounds. An epoxy compound is preferable as the stabilizer. The epoxy compounds may be those stabilizers mentioned as the examples that can be arbitrarily included at the time of modification of the polyolefin resin or of the chlorinated polyolefin resin. Among them, preferable is an epoxy compound compatible with the modified polyolefin resin that is chlorinated. These stabilizers may be used singly; or two or more of them may be concurrently used.

1-4. Form

The resin composition may be in the form of a dispersed resin composition including both the component A and the component B as well as a dispersion medium. In this specification, “the dispersion medium” includes a solvent in which the modified polyolefin resin is dissolvable; and thus, “the dispersed resin composition” may be a solution of the resin composition.

Illustrative examples of the dispersion medium include aromatic hydrocarbons such as toluene and xylene; alicyclic hydrocarbons such as cyclohexane and methyl cyclohexane; aliphatic hydrocarbons such as hexane, heptane, and octane; ketones such as acetone, methyl ethyl ketone, and methyl isobutyl ketone; esters such as methyl acetate, ethyl acetate, n-propyl acetate, isopropyl acetate, and n-butyl acetate; alcohols such as methanol, ethanol, n-propyl alcohol, isopropyl alcohol, n-butyl alcohol, and isobutyl alcohol; glycols such as ethylene glycol, ethyl cellosolve, and butyl cellosolve; and water.

The dispersion medium may be used singly or as a combination of two or more thereof.

1-5. Use of the Resin Composition

The resin composition of the present invention may be used as an adhesive for a metal and/or a resin, as well as for a primer, a paint binder, an ink binder, and the like.

Among them, the resin composition of the present invention is useful as an automobile paint binder and as an automobile paint primer because the composition is superior in the adhesion property thereby capable of providing a primer that can form a coat film that is superior in a chipping resistance.

### EXAMPLES

Hereinafter, the present invention will be explained in detail by Examples. Examples described below is to explain the present invention properly, not to restrict the present invention. The measurement methods of the physical property values and the like are those described before unless specifically mentioned otherwise. Here, “part” is in terms of weight unless specifically mentioned otherwise.

Weight-average Molecular Weight (Mw) and Number-average Molecular Weight (Mn)

These molecular weights of the polyolefin resins produced in Production Examples were measured with GPC in accordance with the conditions described below.

Instrument: HLC-8320GPC (manufactured by Tosoh Corp.)

Column: TSK-gel G-6000 HxL, G-5000 HxL, G-4000 HxL, G-3000 HxL, and G-2000 HxL (manufactured by Tosoh Corp.)

Eluting solution: THF

Flow rate: 1 mL/minute

Temperature: 40° C. (pump oven and column oven)

Injection volume: 100 μL

Standard substance: polystyrene EasiCal PS-1 (manufactured by Agilent Technologies, Inc.)

Content by Percentage of Maleic Anhydride (%)

This was measured by using an alkali titration method in accordance with the method of JIS K 0070 (1992).

Weight Percentage of Acid-Modified Chlorinated Polyolefin Resin Relative to (Meth)acrylate Ester

This was calculated from the use amounts of each component.

Chlorine Content by Percentage (° by Weight)

This was measured with the method in accordance with JIS K7229 (1995).

Stability of Resin Dispersion Solution

Solution characteristics of the toluene dispersion solution of the resin composition including the modified polyolefin resin obtained in Examples and Comparative Examples were visually evaluated immediately after the production thereof and one week after the production thereof in accordance with the following standards. The solutions belonging to the standards A to C are usable.

A: In any of immediately after the production and one week after the production, good solution characteristics are observed without separation of the dispersion solution.

B: In any of immediately after the production and one week after the production, turbidity of the dispersion solution is high but separation of the dispersion solution is not observed.

C: Separation is not observed in the dispersion solution immediately after the production but is observed in the dispersion solution one week after the production.

D: In any of immediately after the production and one week after the production, separation of the dispersion solution is observed.

Paint Stability

Each toluene dispersion solution of the resin composition including the modified polyolefin resin obtained in Examples and Comparative Examples was further blended with toluene to obtain the toluene dispersion solution with the solid concentration of 20% by weight. Into 90 parts of a urethane resin (solid concentration of 30% by weight; manufactured by Hitachi Chemical Co., Ltd.) was added 15 parts of the toluene dispersion solution thus obtained (solid concentration of 20% by weight). The resulting mixture was stirred with a vibration apparatus for 10 minutes; and then, after it was allowed to statically stand at room temperature for 1 day, the solution characteristics thereof were observed. The paint stability (compatibility of the blended resins) was visually evaluated from the separation state of the solution in accordance with the following standards. The solutions belonging to the standards A to C are usable.

A: There is neither increase in the viscosity nor separation in the solution, and the solution characteristics are good.

B: There is a slight increase in the viscosity, but separation and the like are not observed.

C: There is no separation of components, but microparticles are recognized in the solution.

D: Separation of the components is visually recognized.

Attachment Property Test

Linear cuts were made vertically and horizontally on the coat film of a coated plate with the depth until reaching the substrate and with 1 mm interval to make 100 compartments (checkered pattern); and then, after a cellophane adhesive tape adhered onto it, the tape was peeled off to the direction of 180°. Same operation of the adhesion and peel-off of the cellophane adhesive tape was repeated 10 times against the 100 compartments; and then, the attachment property (adhesion property) thereof was evaluated in accordance with the standards described below. When the peeled-off compartments of the coat film are 50 or less, practically there is no problem.

A: There is no peel-off of the coat film.

B: Peeled-off compartments of the coat film is 1 or more and 10 or less.

C: Peeled-off compartments of the coat film is more than 10 and 50 or less.

D: Peeled-off compartments of the coat film is more than 50.

Gasohol Resistance Test

After a coated plate was soaked in a solution of regular gasoline/ethanol=9/1 (v/v) for 120 minutes, the state of the coat film was observed to evaluate the gasohol resistance in accordance with the standards described below. Practically, there is no problem when peel-off is not found on the surface of the coat film.

A: There is no change on the surface of the coat film.

B: A slight change is found on the surface of the coat film, but there is no peel-off found.

C: There is a change on the surface of the coat film, but peel-off does not occur.

D: Peel-off occurs on the surface of the coat film.

Chipping Resistance Test

A coated plate was cooled in a low temperature room cooled to −20° C. The coated plate thus cooled was fixed vertically to a test plate fixing part of a chipping stone tester (JA-400 type; manufactured by Suga Test Instruments Co., Ltd.) so as to be an angle of 90° from a horizontal plane. Then, 100 g of crushed stones (class 7) were blown with an air pressure of 5 kgf/cm′ for 5 seconds to cause scars onto the test plate. Then, after the coated plate was washed with water and dried, a cellophane adhesive tape adhered to the coat film surface. The tape was peeled off by picking-up one end thereof so as to remove the coat film that was raised up from the coated plate by chipping; and the degree of the peeled-off scars was evaluated in accordance with the standards described below. The peeled-off scars were evaluated within the frame of vertical 70 mm and horizontal 70 mm in the bombed part.

A: Best: the peeled-off area percentage of 0.0% or more and less than 0.7° per the evaluated area.

B: Good: the peeled-off area percentage of 0.7° or more and less than 1.2% per the evaluated area.

C: Within acceptable range: the peeled-off area percentage of 1.2% or more and less than 3.5% per the evaluated area.

D: Worst: the peeled-off area percentage of 3.5% or more per the evaluated area.

### Production Example 1: Production of Modified Polyolefin Resin (A-1)

Uniformly 100 parts of a propylene random copolymer (content by percentage of the propylene constituent unit: 96% by weight, and content by percentage of the ethylene constituent unit: 4% by weight) produced as the polyolefin resin by using a metallocene catalyst as the polymerization catalyst, 10 parts of maleic anhydride as the cyclic α,β-unsaturated carboxylic anhydride, and 2 parts of di-t-butyl peroxide as the radical generating agent were mixed and supplied into a biaxial extruder (L/D=60, diameter=15 mm, first barrel to 14^{th} barrel).

The reaction was carried out with a residence time of 10 minutes and a rotation number of 200 rpm, and under barrel temperature conditions of 100° C. (first and second barrels), 200° C. (third to 8^{th} barrels), 90° C. (9^{th} and 10^{th} barrels), and 110° C. (11^{th} to 14^{th} barrels). Then, unreacted maleic anhydride was removed by an evacuation treatment to obtain an acid-modified polypropylene resin modified with maleic anhydride.

Into a glass-lined reaction vessel, 100 parts of the acid-modified polypropylene resin was charged. Then, chloroform was added into the reaction vessel; and after the resin was fully dissolved in chloroform at 110° C. and the pressure of 2 kgf/cm², 2 parts of azobis isobutyronitrile was added to the resulting solution as the radical generating agent; and then, chlorination thereof was carried out by blowing a chlorine gas with controlling the pressure inside the reaction vessel at 2 kgf/cm².

After the reaction, 6 parts of an epoxy compound (Epocizer W-100EL, manufactured by DIC Corp.) was added thereto as the stabilizer; and then, the resulting mixture was supplied into an extruder having a bent equipped with a suction portion for removal of a solvent in a screw shaft portion. After the solvent was removed, this was solidified to obtain an acid-modified chlorinated polyolefin resin as the acid-modified chlorinated polypropylene resin. In the acid-modified chlorinated polyolefin resin thus obtained, the weight-average molecular weight was 110,000, the content by percentage of the maleic anhydride was 4% by weight, and the content by percentage of chlorine was 17° by weight.

Into 108 parts of toluene, 100 parts of the acid-modified chlorinated polyolefin resin was dissolved; and then, 5 parts of an epoxy compound (Epocizer W-131, manufactured by DIC Corp.) was added thereto; and then, 5.5 parts of a peroxy ester peroxide (Perbutyl O, manufactured by NOF Corp.) was further added at 85° C. under a nitrogen atmosphere. Then, monomers (54 parts of 2-ethylhexyl methacrylate and 6 parts of methyl methacrylate) were added as the polymerizable (meth)acrylate esters described as the component C in Table 1. The reaction was carried out at 85° C. for 6 hours to obtain a modified polyolefin resin (A-l). It can be said that the weight-average molecular weight of the modified polyolefin resin (A-1) modified with the low-molecular weight compounds was almost identical with the weight-average molecular weight of the acid-modified chlorinated polyolefin resin.

### Production Example 2: Production of Modified Polyolefin Resin (A-2)

Uniformly 100 parts of a propylene random copolymer (content by percentage of the propylene constituent unit: 80° by weight, and content by percentage of the ethylene constituent unit: 20% by weight) produced as the polyolefin resin by using a metallocene catalyst as the polymerization catalyst, 20 parts of maleic anhydride as the cyclic α,β-unsaturated carboxylic anhydride, and 6 parts of di-t-butyl peroxide as the radical generating agent were mixed and supplied into a biaxial extruder (L/D=60, diameter=15 mm, first barrel to 14^{th} barrel).

The reaction was carried out with a residence time of 10 minutes and a rotation number of 200 rpm, and under barrel temperature conditions of 100° C. (first and second barrels), 200° C. (third to 8^{th} barrels), 90° C. (9^{th} and 10^{th} barrels), and 110° C. (11^{th} to 14^{th} barrels). Then, unreacted maleic anhydride was removed by an evacuation treatment to obtain an acid-modified polypropylene resin modified with maleic anhydride.

Into a glass-lined reaction vessel, 100 parts of the acid-modified polypropylene resin was charged. Then, chloroform was added into the reaction vessel; and after the resin was fully dissolved in chloroform at 110° C. and the pressure of 2 kgf/cm², 4 parts of azobis isobutyronitrile was added to the resulting solution as the radical generating agent; and then, chlorination thereof was carried out by blowing a chlorine gas with controlling the pressure inside the reaction vessel at 3 kgf/cm².

After the reaction, 6 parts of an epoxy compound (Epocizer W-100EL, manufactured by DIC Corp.) was added thereto as the stabilizer; and then, the resulting mixture was supplied into an extruder having a bent equipped with a suction portion for removal of a solvent in a screw shaft portion. After the solvent was removed, this was solidified to obtain an acid-modified chlorinated polyolefin resin as the acid-modified chlorinated polypropylene resin. In the acid-modified chlorinated polyolefin resin thus obtained, the weight-average molecular weight was 200,000, the content by percentage of the maleic anhydride was 10% by weight, and the content by percentage of chlorine was 40% by weight.

Into 108 parts of toluene, 100 parts of the acid-modified chlorinated polyolefin resin was dissolved; and then, 5 parts of an epoxy compound (Epocizer W-131, manufactured by DIC Corp.) was added thereto; and then, 5.5 parts of a peroxy ester peroxide (Perbutyl 0, manufactured by NOF Corp.) was further added at 85° C. under a nitrogen atmosphere. Then, monomers (54 parts of 2-ethylhexyl methacrylate and 6 parts of cyclohexyl methacrylate) were added as the polymerizable (meth)acrylate esters described as the component C in Table 1. The reaction was carried out at 85° C. for 6 hours to obtain a modified polyolefin resin (A-2). It can be said that the weight-average molecular weight of the modified polyolefin resin (A-2) modified with the low-molecular weight compounds was almost identical with the weight-average molecular weight of the acid-modified chlorinated polyolefin resin.

### Production Example 3: Production of Modified Polyolefin Resin (A-3)

Uniformly 100 parts of a propylene random copolymer (content by percentage of the propylene constituent unit: 75° by weight, content by percentage of the ethylene constituent unit: 15% by weight, and content by percentage of the butene constituent unit: 10% by weight) produced as the polyolefin resin by using a metallocene catalyst as the polymerization catalyst, 4 parts of maleic anhydride as the cyclic α,β-unsaturated carboxylic anhydride, and 8 parts of di-t-butyl peroxide as the radical generating agent were mixed and supplied into a biaxial extruder (L/D=60, diameter=15 mm, first barrel to 14^{th} barrel).

The reaction was carried out with a residence time of 10 minutes and a rotation number of 200 rpm, and under barrel temperature conditions of 100° C. (first and second barrels), 200° C. (third to 8^{th} barrels), 90° C. (9^{th} and 10^{th} barrels), and 110° C. (11^{th} to 14^{th} barrels). Then, unreacted maleic anhydride was removed by an evacuation treatment to obtain a modified polypropylene resin modified with maleic anhydride (A-3). In the modified polyolefin resin thus obtained, the weight-average molecular weight was 20,000, and the content by percentage of the maleic anhydride was 2.5% by weight.

### Production Example 4: Production of Modified Polyolefin Resin (A-4)

Uniformly 100 parts of a propylene random copolymer (content by percentage of the propylene constituent unit: 96% by weight, and content by percentage of the ethylene constituent unit: 4% by weight) produced as the polyolefin resin by using a metallocene catalyst as the polymerization catalyst, 10 parts of maleic anhydride as the cyclic α,β-unsaturated carboxylic anhydride, and 2 parts of di-t-butyl peroxide as the radical generating agent were mixed and supplied into a biaxial extruder (L/D=60, diameter=15 mm, first barrel to 14^{th} barrel).

The reaction was carried out with a residence time of 10 minutes and a rotation number of 200 rpm, and under barrel temperature conditions of 100° C. (first and second barrels), 200° C. (third to 8^{th} barrels), 90° C. (9^{th} and 10^{th} barrels), and 110° C. (11^{th} to 14^{th} barrels). Then, unreacted maleic anhydride was removed by an evacuation treatment to obtain an acid-modified polypropylene resin modified with maleic anhydride.

Into a glass-lined reaction vessel, 100 parts of the acid-modified polypropylene resin was charged. Then, chloroform was added into the reaction vessel; and after the resin was fully dissolved in chloroform at 110° C. and the pressure of 2 kgf/cm², 2 parts of azobis isobutyronitrile was added to the resulting solution as the radical generating agent; and then, chlorination thereof was carried out by blowing a chlorine gas with controlling the pressure inside the reaction vessel at 2 kgf/cm².

After the reaction, 6 parts of an epoxy compound (Epocizer W-100EL, manufactured by DIC Corp.) was added thereto as the stabilizer; and then, the resulting mixture was supplied into an extruder having a bent equipped with a suction portion for removal of a solvent in a screw shaft portion. After the solvent was removed, this was solidified to obtain an acid-modified chlorinated polyolefin resin as the acid-modified chlorinated polypropylene resin. In the acid-modified chlorinated polyolefin resin thus obtained, the weight-average molecular weight was 110,000, the content by percentage of the maleic anhydride was 4% by weight, and the content by percentage of chlorine was 17% by weight.

Into 108 parts of toluene, 100 parts of the acid-modified chlorinated polyolefin resin was dissolved; and then, 5 parts of an epoxy compound (Epocizer W-131, manufactured by DIC Corp.) was added thereto; and then, 5.5 parts of a peroxy ester peroxide (Perbutyl 0, manufactured by NOF Corp.) was further added at 85° C. under a nitrogen atmosphere. Then, monomers (58 parts of cyclohexyl methacrylate and 2 parts of 2-hydroxyethyl acrylate) were added as the polymerizable (meth)acrylate esters described as the component C in Table 1. The reaction was carried out at 85° C. for 6 hours to obtain a modified polyolefin resin (A-4). It can be said that the weight-average molecular weight of the modified polyolefin resin (A-4) modified with the low-molecular weight compounds was almost identical with the weight-average molecular weight of the acid-modified chlorinated polyolefin resin.

A list of the (modified) polyolefin resins produced in Production Examples 1 to 4 is described in Table 1 below.

TABLE 1

| | Component A | | | | | | | | | |
|---|---|---|---|---|---|---|---|---|---|---|
| | | Weight-average | Chlorination degree | Chlorination: | | Component C | | | | |
| | Number | molecular weight | (% by weight) | Yes or No | MAH modification | EHMA | EHA | MMA | CHMA | HEAA |
| Production | A-1 | 110,000 | 17 | Yes | 4% by weight | 90 | — | 10 | — | — |
| Example 1 | | | | | | | | | | |
| Production | A-2 | 200,000 | 40 | Yes | 10% by weight | — | 90 | — | 10 | — |
| Example 2 | | | | | | | | | | |
| Production | A-3 | 20,000 | — | Yes | 2.5% by weight | — | — | — | — | — |
| Example 3 | | | | | | | | | | |
| Production | A-4 | 110,000 | 17 | Yes | 4% by weight | — | — | — | 97 | 3 |
| Example 4 | | | | | | | | | | |

Abbreviated names in Table 1 are as follows. Here, in Table 1, the numbers below the column of the abbreviations of the component C are the ratios to the total amount of the component C.

MAH: maleic anhydride

EHMA: 2-ethylcyclohexyl methacrylate

EHA: 2-ethylcyclohexyl acrylate

MMA: methyl methacrylate

CHMA: cyclohexyl methacrylate

HEA: 2-hydroxyethyl acrylate

### Production Example 5: Production of Polymer (B-1)

To 95 parts of 2-ethylhexyl methacrylate and 5 parts of divinyl benzene was added 1 part of thiolactic acid; and then, the reaction of them was carried out under a nitrogen atmosphere at 95° C. for 12 hours. The reaction product was transferred to an evaporator to remove the remaining monomers and the remaining thiol compound by heating at 80° C. under a reduced pressure to obtain a polymer (B-1) as a copolymer of the (meth)acrylate and divinyl benzene. The number-average molecular weight of the polymer (B-1) thus obtained was 3,000.

### Production Examples 6 to 11: Production of Polymers (B-2) to (B-7)

The polymers (B-2) to (B-7) were obtained with the same way as Production Example 5 except that the raw materials and the polymerization initiators described in Table 2 were used. The number-average molecular weights of these polymers are also described in Table 2.

A list of the polymers produced in Production Examples 5 to 11 is described in Table 2 below.

TABLE 2

| | Component B | | | | | | | | | | |
|---|---|---|---|---|---|---|---|---|---|---|---|
| | | | Component | | | | | | | | Number-average |
| | Number | Initiator | DVBn | EHMA | EHA | MAA | HEMA | MMA | n-BMA | total | molecular weight |
| Production | B-1 | Thiolactic acid | 5 | 95 | 0 | 0 | 0 | 0 | 0 | 100 | 3,000 |
| Example 5 | | | | | | | | | | | |
| Production | B-2 | Thiolactic acid | — | 50 | 40 | 0 | 10 | 0 | 0 | 100 | 1,000 |
| Example 6 | | | | | | | | | | | |
| Production | B-3 | Thiolactic acid | 5 | 30 | 0 | 15 | 0 | 50 | 0 | 100 | 20,000 |
| Example 7 | | | | | | | | | | | |
| Production | B-4 | Thiolactic acid | 5 | 50 | 45 | 0 | 0 | 0 | 0 | 100 | 30,000 |
| Example 8 | | | | | | | | | | | |
| Production | B-5 | Thiolactic acid | 5 | 65 | 0 | 10 | 10 | 10 | 0 | 100 | 700 |
| Example 9 | | | | | | | | | | | |
| Production | B-6 | Perbutyl O | 5 | 95 | 0 | 0 | 0 | 0 | 0 | 100 | 3,000 |
| Example 10 | | | | | | | | | | | |
| Production | B-7 | Thiolactic acid | 5 | 0 | 0 | 0 | 0 | 0 | 95 | 100 | 3,000 |
| Example 11 | | | | | | | | | | | |

Abbreviated names in Table 2 are described below.

DVBn: divinyl benzene

EHMA: 2-ethylcyclohexyl methacrylate

EHA: 2-ethylcyclohexyl acrylate

MAA: methacrylic acid

HEMA: 2-hydroxyethyl methacrylate

MMA: methyl methacrylate

n-BMA: normal butyl methacrylate

### Example 1: Resin Composition

To 80 parts of the modified polyolefin resin (A-1) produced in Production Example 1 was added 20 parts of the polymer (B-1) produced in Production Example 5; and then, a dispersed resin composition was prepared so as to control the solid portion therein at 20% by weight and the solvent composition of toluene/cyclohexane at 70/30. With regard to the dispersed resin composition thus prepared, stability of the resin dispersion solution and the paint stability were evaluated. In addition, the test pieces were prepared; and these were subjected to the adhesion test, the gasohol resistance test, and the chipping resistance test. These evaluation results are also included in Table 3.

### Examples 2 to 3 and Comparative Examples 1 to 3: Resin Compositions

The dispersed resin composition was prepared with the same way as Example 1 except that the components described Table 3 were used. With regard to the dispersed resin composition thus prepared, stability of the resin dispersion solution and the paint stability were evaluated. In addition, the test pieces were prepared; and these were subjected to the adhesion test, the gasohol resistance test, and the chipping resistance test. These evaluation results are also included in Table 3.

### Example 4: Resin Composition

After 20 parts of the polymer (B-1) produced in Production Example 5 was added to 80 parts of the modified polyolefin resin (A-3) produced in Production Example 3, 100 parts of the resin composition was charged into a glass-lined reaction vessel. Then, chloroform was added into the reaction vessel; and after the resin was fully dissolved in chloroform at 110° C. and the pressure of 2 kgf/cm², 2 parts of azobis isobutyronitrile was added to the resulting solution as the radical generating agent; and then, chlorination thereof was carried out by blowing a chlorine gas with controlling the pressure inside the reaction vessel at 2 kgf/cm².

After the reaction, 6 parts of an epoxy compound (Epocizer W-100EL, manufactured by DIC Corp.) was added thereto as the stabilizer; and then, the resulting mixture was supplied into an extruder having a bent equipped with a suction portion for removal of a solvent in a screw shaft portion. After the solvent was removed, this was solidified to obtain a chlorinated, dispersed resin composition. In the dispersed resin composition thus obtained, the content by percentage of chlorine was 18% by weight.

With regard to the dispersed resin composition thus prepared, stability of the resin dispersion solution and the paint stability were evaluated. In addition, the test pieces were prepared; and these were subjected to the adhesion test, the gasohol resistance test, and the chipping resistance test. These evaluation results are also included in Table 3.

### Example 5: Resin Composition

The dispersed resin composition was prepared with the same way as Example 1 except that the components described Table 3 were used. With regard to the dispersed resin composition thus prepared, stability of the resin dispersion solution and the paint stability were evaluated. In addition, the test pieces were prepared; and these were subjected to the adhesion test, the gasohol resistance test, and the chipping resistance test. These evaluation results are also included in Table 3.

TABLE 3

| | | | | Stability of resin | | | | |
|---|---|---|---|---|---|---|---|---|
| | Component A | Component B | | dispersion | | Adhesion | | |
| | Number | Number | A/B | solution | Paint stability | property | Gasohol resistance | Chipping resistance |
| Example 1 | A-1 | B-1 | 80/20 | B | A | A | A | B |
| Example 2 | A-2 | B-2 | 50/50 | A | A | B | B | A |
| Example 3 | A-3 | B-3 | 90/10 | C | C | B | B | C |
| Example 4 | A-3 | B-1 | 80/20 | B | B | A | B | B |
| Example 5 | A-4 | B-7 | 80/20 | B | A | A | A | A |
| Comparative | A-1 | B-4 | 80/20 | B | B | D | D | C |
| Example 1 | | | | | | | | |
| Comparative | A-2 | B-5 | 80/20 | D | D | D | D | D |
| Example 2 | | | | | | | | |
| Comparative | | | | | | | | |
| Example 3 | A-3 | B-6 | 80/20 | D | D | D | C | D |

The test piece was prepared as follows. Each dispersion solution, obtained in Examples and Comparative Examples and having the solid concentration therein controlled at 30% by weight, was applied onto a polypropylene substrate, and then, this was dried at 80° C. for 5 minutes. Then, a two-liquid urethan paint was applied to it; and then, this was dried at 80° C. for 30 minutes to prepare the test piece (coated plate).

1. A resin composition, comprising: component A and a following component B:
as component A, a modified polyolefin resin; and
as component B, a polymer comprising a functional group at least in a terminal thereof, and having a number-average molecular weight in a range of from 1,000 to 20,000, and comprising a constituent unit (i) derived from a (meth)acrylate ester of formula (1):
CH₂═C(R¹)COOR² (1),
wherein
R¹ is a hydrogen atom or a methyl group,
R² is a —CₙH₂ₙ₊₁ group, and
n is an integer in a range of from 1 to 18.

2. The composition of claim 1, wherein the modified polyolefin resin is modified with a (meth)acrylate ester as a component C.

3. The composition of claim 1, wherein the constituent unit (i) comprises 40% or more of a constituent unit (i-i) derived from a (meth)acrylate ester having a carbon atom number in a range of from 4 to 12 in the compound of formula (1).

4. The composition of claim 2, wherein the component C is a (meth)acrylate ester having a carbon atom number in a range of from 4 to 12.

5. The composition of claim 1, wherein the component A is a chlorinated polyolefin resin.

6. The composition of claim 1, wherein the component A has a weight-average molecular weight in a range of from 20,000 to 200,000.

7. The composition of claim 1, wherein the terminal functional group is a carboxy group.

8. A primer, comprising the composition of claim 1.

9. The composition of claim 1, wherein the polyolefin resin is a polypropylene resin.

10. The composition of claim 1, wherein the polyolefin resin comprises, in polymerized form, propylene and a further α-olefin.

11. The composition of claim 1, wherein the polyolefin resin comprises, in polymerized form,
propylene, and
ethylene, butene, 3-methyl-1-butene, and/or 3-methyl-1-heptene.

12. The composition of claim 1, wherein the polyolefin resin comprises, in polymerized form, propylene and ethylene.

13. The composition of claim 1, wherein the polyolefin resin comprises, in polymerized form, propylene and butene.

14. The composition of claim 1, wherein the polyolefin resin comprises, in polymerized form, ethylene, propylene, and butene.

15. The composition of claim 1, wherein the polyolefin resin comprises, in polymerized form, at least 60 wt. % propylene, based on total polyolefin resin weight.

16. The composition of claim 1, wherein the polyolefin resin is modified with 2-ethylhexyl (meth)acrylate.

17. The composition of claim 1, wherein the polyolefin resin is modified with methyl (meth)acrylate.

18. The composition of claim 1, wherein the polyolefin resin is modified with cyclohexyl (meth)acrylate, butyl (meth)acrylate, and/or 2-hydroxyethyl (meth)acrylate
